(19) United States
(12) Patent Application Publication
(10) Pub. No.: US 2015/0200785 A1
(43) Pub. Date: Jul. 16, 2015

(54) METHOD AND APPARATUS FOR MANAGING ACTIVITIES IN A WEB CONFERENCE

(71) Applicant: Adobe Systems Incorporated, San Jose, CA (US)

(72) Inventors: Sumeet Gupta, New Delhi (IN); Mili Sharma, Patiala (IN)

(73) Assignee: Adobe Systems Incorporated, San Jose, CA (US)

(21) Appl. No.: 14/152,443

(22) Filed: Jan. 10, 2014

(51) Int. Cl. H04L 12/18; H04L 29/08

(52) U.S. Cl. CPC H04L 12/1822; H04L 67/22

(57) ABSTRACT

A computer implemented method and apparatus for managing activities in a web conference. The method and apparatus segment participants of a web conference into a plurality of groups and presents to each group in the plurality of groups one or more conference activities. The one or more conference activities for a first group in the plurality of groups are different from the one or more conference activities for a second group in the plurality of groups.

### BACKGROUND OF THE INVENTION

1. Field of the Invention

Embodiments of the present invention generally relate to web conferencing and, more particularly, to a method and apparatus for managing activities in a web conference.

2. Description of the Related Art

With the rapid growth of the Internet and ubiquitous broadband access, people are moving to online meetings, presentations and collaboration using various web based tools such as ADOBE CONNECT® available from Adobe Systems Incorporated. A web conference allows conferencing events, such as web meetings, eLearning and webinars to be shared with remote locations. There may be one or more hosts who present a presentation to a plurality of other people. The people involved in the web conference are referred to herein as participants. Such a presentation may include any form of content (e.g., images, text, messages, multimedia and the like) that is disclosed by one or more people to other participants for any purpose (e.g., discussion, collaboration, training, sharing and the like).

Therefore, there is a need for a method and apparatus for managing activities in a web conference in order to provide an improved web conference experience for the participants, as well as a host.

### SUMMARY OF THE INVENTION

A method for managing activities in a web conference is described. The method segments participants of a web conference into a plurality of groups and then presents each group in the plurality of groups one or more conference activities, where the one or more conference activities for a first group in the plurality of groups is different from the one or more conference activities for a second group in the plurality of groups.

In another embodiment, an apparatus for managing activities in a web conference is described. The apparatus segments participants of a web conference into a plurality of groups and then presents each group in the plurality of groups one or more conference activities, where the one or more conference activities for a first group in the plurality of groups is different from the one or more conference activities for a second group in the plurality of groups.

In yet another embodiment, a computer readable medium for managing activities in a web conference is described. The computer readable medium storing computer instructions that, when executed by at least one processor causes the at least one processor to segment participants of a web conference into a plurality of groups; and to present each group in the plurality of groups one or more conference activities, wherein the one or more conference activities for a first group in the plurality of groups is different from the one or more conference activities for a second group in the plurality of groups.

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a web-based conferencing system for managing activities in a web conference, according to one or more embodiments;

FIG. 2 depicts a flow diagram of a method for scheduling a web conference with group specific conference activities as performed by the conference setup module of FIG. 1, according to one or more embodiments; and

FIG. 3 depicts a flow diagram of a method for presenting activities to one or more dynamically selected segments of participants of the web conference, as performed by the conference management module of FIG. 1, according to one or more embodiments.

While the method and apparatus is described herein by way of example for several embodiments and illustrative drawings, those skilled in the art will recognize that the method and apparatus for managing activities in a web conference is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the method and apparatus for managing activities in a web conference defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

As previously explained, currently, in a web conference, communication can only be between individuals or to all participants of the web conference This is problematic should, for example, a host wish to comment on proprietary information during a web conference, where access to the proprietary information is restricted to a small group of web conference participants.

Thus, and in accordance with an embodiment of the present invention, techniques are provided herein that allow for grouping participants of a web conference and displaying conference activities to specific groups of participants. Embodiments of the present invention include a method and apparatus for managing activities in a web conference. A server receives one or more rules from a web conference host for segmenting participants in a web conference into groups. The method also receives activities to be separately presented to each group. During the web conference, when an activity, such as a poll is presented to the participants of a web conference, the method may further segment the participants into groups based on responses to the poll. The group to which a participant is assigned is based on the one or more rules.

After segmentation, the experience during the web conference for each group is different. Each group is presented with activities (i.e., presentation slides, polls, and the like) specifically defined for the group, at pre-defined times during the web conference. At any time during the web conference, a host may create a new activity to be presented to one or more groups. The response to the new activity may, according to newly specified rules, assign one or more participants to a new group. As the web conference progresses, groups may change dynamically based on responses to activities in the web conference.

Advantageously, embodiments of the present invention provide a host of a web conference the ability to tailor what is presented to groups of participants within a web conference. The invention is beneficial to users of web conferencing software, such as ADOBE® CONNECT™ and the like.

Various embodiments of a method and apparatus for managing activities in a web conference are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

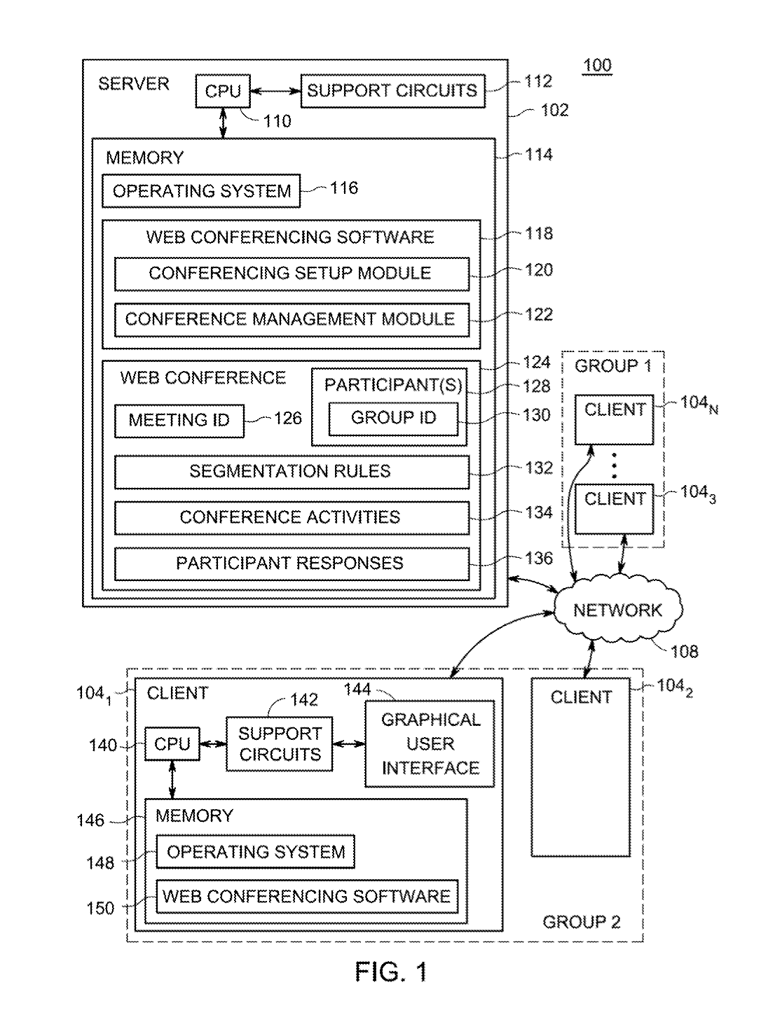

FIG. 1 depicts a block diagram of a web-based conferencing system 100 for managing activities in a web conference, in accordance with at least one embodiment of the invention. The system 100 includes a server 102 connected to a plurality of clients 104 via a communications network 108.

The server 102 is a computing device, for example a desktop computer, laptop, tablet computer, smart phone, personal digital assistant (PDA), cellular phone, and the like that can act as a web conferencing server. The server 102 includes a Central Processing Unit (CPU) 110, support circuits 112, and a memory 114. The CPU 110 may include one or more commercially available microprocessors or microcontrollers that facilitate data processing and storage. The various support circuits 112 facilitate the operation of the CPU 110 and include one or more clock circuits, power supplies, cache, input/output circuits, and the like. The memory 114 includes at least one of Read Only Memory (ROM), Random Access Memory (RAM), disk drive storage, optical storage, removable storage and/or the like. The server 102 facilitates distribution of content (e.g., presentation slides, text chat messages, polls, and the like) to one or more groups of participants who are participating in the web conference.

The memory 114 includes an operating system 116, web conferencing software 118, and one or more web conferences 124. The web conferencing software 118 includes a conference setup module 120 and a conference management module 122. Each web conference 124 includes a meeting ID 126, a plurality of participants 128, segmentation rules 132, conference activities 134, and participant responses 136. Each participant 128 includes a group ID 130.

Each client 104 is a computing device, for example a desktop computer, laptop, tablet computer, smart phone, personal digital assistant (PDA), cellular phone, and the like. The client 104 includes a Central Processing Unit (CPU) 140, support circuits 142, a memory 146, and includes or is connected to a graphical user interface 144. The graphical user interface 144 includes a display (not specifically shown). The CPU 140 may include one or more commercially available microprocessors or microcontrollers that facilitate data processing and storage. The various support circuits 142 facilitate the operation of the CPU 140 and include one or more clock circuits, power supplies, cache, input/output circuits, and the like. The memory 148 includes at least one of Read Only Memory (ROM), Random Access Memory (RAM), disk drive storage, optical storage, removable storage and/or the like. The memory 146 includes an operating system 148, and web conferencing software 150. The graphical user interface 144 of one or more clients 104 are used by one or more web conference hosts to set up and run a web conference. The graphical user interface 144 of one or more clients 104 is also used by one or more participants to facilitate their participation in a web conference.

The network 108 includes a communication system that connects computers (or devices) by wire, cable, fiber optic and/or wireless link facilitated by various types of well-known network elements, such as hubs, switches, routers, and the like. The network 108 may be a part of an Intranet using various communications infrastructure, such as Ethernet, Wi-Fi, a personal area network (PAN), a wireless PAN, Bluetooth, Near field communication, and the like.

In one embodiment, an on-line (e.g., a web) presentation environment is provided through execution of the web conferencing software 118 on the server 102, where such software may include, as a non-limiting example, ADOBE® CONNECT™ available from Adobe Systems Incorporated. A web conference allows conferencing events, such as web meetings, eLearning and webinars to be shared with remote locations. ADOBE® CONNECT™ provides web-based conferencing to facilitate multiuser collaboration via chat rooms, digital audio discussions, presentations, webinars, and the like.

A web conference host, typically the person who schedules the web conference, uses the web conferencing software 150 on a client 104 to interface with the conference setup module 120 on the server 102 in order to schedule a web conference 124. The host uses the graphical user interface 144 to enter participants 128 that are to be invited to take part in the web conference 124. The host also enters conference activities 134. Conference activities 134 include polls, text chat messages, presentation slides and the like that are displayed to participants 128 during the web conference 124. The conference setup module 120 assigns a meeting ID 126 and stores the conference activities 134. The host specifies a time when each of the conference activities 134 are to be displayed during the web conference 124 and to what group of participants 128 the conference activities 134 are to be displayed. The conference setup module 120 stores the schedule information with the conference activities 134.

The web conference host creates segmentation rules 132 that are then stored by the conference setup module 120. Segmentation rules 132 define how to segment participants 128 into groups. Segmentation rules 132 may pre-segment the participants 128 into groups before the start of the web conference 124 based on such parameters as age, company ID, user profile, or any other property or attribute related to the participant 128. For example, all participants 128 with a company ID of ADOBE may be segmented into Group1. The remaining participants 128 (i.e., participants with a company ID that is not ADOBE) are segmented into Group2.

Segmentation rules 132 may be used to map responses to conference activities 134 thereby dynamically grouping participants 128 during the web conference 124. For example, proceeding from the pre-segmented participants above, a first conference activity 134 may be a poll asking each participant 128 if the participant 128 is a current subscriber to ADOBE CREATIVE CLOUD. A segmentation rule 132 may be, for example, if the response is yes, assign the participant 128 to Group3 and if the response is no assign the participant 128 to Group4. As such, the groupID 130 of a participant 128 may change throughout the web conference 124. In some embodiments, a participant 128 may be locked into a group, such that their groupID may not be changed.

Once the participants are segmented into groups, the experience for each group is different. For example, a conference activity 134 may be to present a text chat to participants with a group ID of Group3. The text chat may ask for feedback regarding what aspects of ADOBE CREATIVE CLOUD they like most. The feedback is stored in participant responses 136. A conference activity 134 may be to present a text chat to participants 128 with a group ID of Group4, where the text chat includes participant responses 136. Specifically, the positive feedback from participants 128 with CREATIVE CLOUD subscriptions is presented to participants 128 who do not have a CREATIVE CLOUD subscription. Any manner of determining positivity of feedback may be utilized. For example, a sentiment analyzer may be used to determine how positive feedback is. Hence, the web conference host may dynamically group the participants 128 of a web conference 124 and use feedback from participants 128 in a first group to promote a product to participants 128 in a second group. Segmentation rules 132 may be based on polling results, keywords entered in a chat area, and the like.

At the scheduled time, the conference management module 122 initiates the web conference 124. The conference management module 122 accesses the segmentation rules 132 to determine if any pre-segmentation of the participants 128 is specified. If so, the conference management module 122 assigns a groupID 130 to each participant 128.

The conference management module 122 displays on the graphical user interface 144 of clients 104, conference activities (i.e., presentation slide, polling questions, text chats, and the like as defined in the conference activities 134. For example, a conference activity 134 may be a slide presentation. The slide presentation may be defined to start at the start time of the web conference 124. Assuming no pre-segmentation was defined for the start of the web conference 124, the slide presentation is displayed to all participants 128 via the graphical user interface 144. A second conference activity 134, for example a poll may be scheduled for display after, for example, a 5^{th} slide or for example 10 minutes after the start of the web conference 124.

Per the schedule defined in the conference activities 134, the conference management module 122 displays the poll to all participants 128. The participants 128 may respond via the graphical user interface 144. The conference management module 122 receives responses to the poll and accesses the segmentation rules 132 to determine whether any segmentation is specified based on the responses to the poll. If segmentation is specified based on the response to the poll, the conference management module 122 assigns an appropriate groupID 130 to each participant 128 based on their response. For example, a poll may be in the form of a question with multiple choice responses. A segmentation rule 132 may state that participants who respond with choice a) are assigned to Group1, participants who respond with choice a) are assigned to Group1, participants who respond with choice b) are assigned to Group2, participants who respond with choice c) are assigned to Group3, and participants who do not respond are assigned to Group 4. As the web conference 124 progresses, the conference management module 122 displays conference activities 134. A conference activity 134 may include a first poll that is to be displayed to those participants 128 in Group1 and Group2, and a second poll that is to be displayed to those participants 128 in Group3 and Group4. The conference management module 122 determines the GroupID 130 for each participant 128 and displays the appropriate poll or other conference activity 134 via the web conferencing software 150 on the client 104.

Throughout the web conference 124 the GroupID 130 of a participant 128 may change, and the conference management module 122 displays the conference activities 134 to each participant 128 based on the GroupID 130.

The host of the web conference 124 may view a dashboard on the graphical user interface 144. The dashboard is a display of a plurality of views of the web conference 124, in some embodiments, one view for each group of participants 128. As such, the host can see what is displayed to each group on the graphical user interface 144. In addition, the host may create conference activities 134 during the web conference 124. For example, if a large number of participants 128 responded that they do not have a subscription to ADOBE CREATIVE CLOUD, the host may, after seeing the responses, create a poll or text chat requesting more information and then further segment the participants 128 into additional groups in order to address responses received from the poll or text chat. The conference management module 122 displays the created conference activities 134 to one or more groups of participants 128.

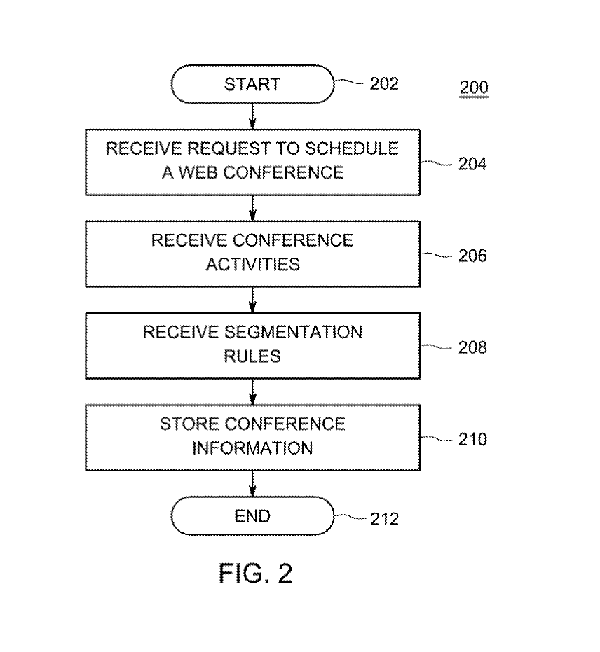

FIG. 2 depicts a flow diagram of a method 200 for scheduling a web conference with group specific conference activities as performed by the conference setup module 120 of FIG. 1, according to one or more embodiments. The method 200 stores segmentation rules and conference activities for a web conference. The steps of method 200 may be performed in an order other than the order illustrated herein without deviating from the invention. The method 200 starts at step 202 and proceeds to step 204.

At step 204, the method 200 receives a request to schedule a web conference. The method 200 receives information regarding the web conference, for example, participants for the web conference, a scheduled time for the web conference, a universal resource location (URL) for the web conference, and the like. The method 200 assigns a meeting ID to the web conference and stores the received information.

The method 200 proceeds to step 206, where the method 200 receives conference activities that are created for the web conference. A conference activity may be presentation slides, a poll, a text chat, and the like. Each conference activity is associated with a time for the conference activity to be displayed. In addition, each conference activity is associated with a group of participants to which it is to be displayed. For example, a poll may be a question, “Do you live in the United States of America?” The poll may be scheduled at a specific time after the web conference begins or the poll may be scheduled at a time when a specified presentation slide is displayed. Lastly, the poll has a group of participants that are to view the poll. The group is associated with a groupID of the participant. For example, the poll may be defined to be displayed to Group2 and Group4. Alternately, the poll may be defined to be displayed to “all” participants.

The method 200 proceeds to step 208, where the method 200 receives segmentation rules. The segmentation rules may segment the participants into groups at the start of the web conference. In addition, the segmentation rules may segment the participants into groups one or more times based on responses to conference activities responded to during the web conference. For example, from the exemplary poll above, a segmentation rule may be: “participants who answer yes are assigned to Group1; participants who answer no are assigned to Group2.” A segmentation rule may be based on responses to polls, text chat messages, and the like. The segmentation rule may also be based on static information such as an email address, or company identifier.

The method 200 proceeds to step 210, where the method 200 stores the conference activities and segmentation rules for use later during the web conference. The method 200 proceeds to step 212 and ends.

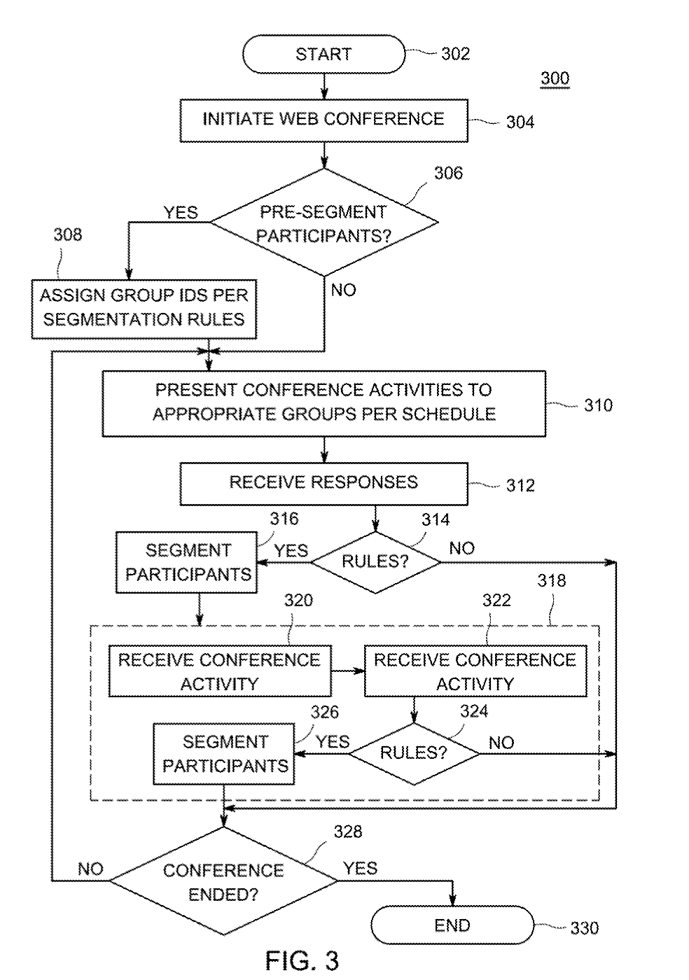

FIG. 3 depicts a flow diagram of a method 300 for presenting activities to one or more groups of participants of a web conference, as performed by the conference management module 122 of FIG. 1, according to one or more embodiments. The method 300 segments the participants of a web conference into groups. The method 300 displays conference activities to each group independently, as each conference activity is specifically defined for one or more groups. The method 300 starts at step 302 and proceeds to step 304.

At step 304, the method 200 initiates a web conference.

The method 300 proceeds to step 306, where the method 300 determines whether any segmentation rules exist that segment the participants at the start of the web conference. For example, a segmentation rule may be that defined participants that have an ADOBE email address are assigned a groupID of Group1 and all other participants are assigned a groupID of Group2. This grouping may be helpful if, for example a host of the web conference wishes to present a poll to ADOBE employees regarding proprietary company information. In such case, the poll would be directed to participants with a groupID of Group1.

If the method 300 determines that there are no segmentation rules that require the participants to be segmented into groups at the start of the web conference, the method 300 proceeds to step 310. However, if the method 300 determines that there are segmentation rules that require the participants to be segmented at the start of the web conference, the method 300 proceeds to step 308, where the method 300 assigns the appropriate groupID to each participant and stores the groupID with participant information for the web conference. The method 300 then proceeds to step 310.

At step 310, the method 300 presents conference activities to one or more groups of participants. For example, a first conference activity may be a poll that is to be presented to each participant with a groupID of Group1 after the display of a fifth presentation slide. A second conference activity may be a text chat that is to be presented to each participant with a groupID of Group2 after the display of the fifth presentation slide. Each conference activity is presented to the appropriate group per the schedule and group information of the conference activity. In addition, a designated host of the web conference is presented with a display that provides a view of what each group is seeing.

Initially, the participants may not be segmented into groups, in which case a first conference activity may be presented to all participants. For example, a marketing team of ADOBE India may conduct a webinar on “Creative Cloud—Key Features” for a large set of users in India, which consists of the following groups:
Participants who are existing Creative Cloud users
Participants who are planning to purchase Creative Cloud and are based in Delhi
Participants who are planning to purchase Creative Cloud and are based outside of Delhi

Two polls may be presented to all participants. A first poll may be:

Poll 1: What is your Creative Cloud subscription status?
a) Have purchased a Creative Cloud license
b) Are planning to purchase Creative Cloud in the near future
c) None of the above.

A second poll may be:

Poll 2: What is your location?
a) Bangalore
b) Chennai
c) Delhi NCR
d) Mumbai
e) Other

The method 300 proceeds to step 312, where the method 300 receives responses from the participants of the conference activity. In some embodiments, the method 300 stores the responses to the conference activities. The method 300 proceeds to step 314.

At step 314, the method 300 determines whether any segmentation rules exist based on responses to the polls. The method 300 accesses the segmentation rules that may map groupIDs to responses. For example, a segmentation rule for the polls may be as follows:
participants who selected response “a” in Poll 1 (i.e., participants who are existing Creative Cloud users) are assigned a groupID of Group1
participants who selected response “b” in Poll 1 and selected response “c” in

Poll 2 (i.e., participants who are planning to purchase Creative Cloud and are based in Delhi NCR) are assigned a groupID of Group2
participants who selected response “b” in Poll 1 and selected response “a” or “b” or “d” in Poll 2 (i.e., participants who are planning to purchase Creative Cloud and are based outside of Delhi NCR) are assigned a groupID of Group3
all participants (i.e., all participants in the above three groups) are also assigned a groupID of Group4

The method 300 proceeds to step 316, where the method 300 assigns the appropriate one or more groupIDs to each participant, based on the above segmentation rules. Thereafter, based on the groupIDs assigned to each participant, each group may see different pre-defined conference activities. For example, a first conference activity for Group 2 may be to present presentation slides that show discount information on a Creative Cloud purchase and details of promotional events planned in the future for Delhi NCR. A second conference activity for Group 2 may be to display in a chat area of the web conference, at specified times, discount information on a Creative Cloud purchase and details of promotional events planned in the future for Delhi NCR. A third conference activity may be to present discount information on a Creative Cloud purchase to Group 3 at specified times during the web conference.

The method 300 optionally proceeds to block 318, where a host of a web conference may create a new conference activity during the web conference. For example, the host may want input from satisfied customers of Creative Cloud regarding the features of Creative Cloud that they like the most. The method 300 proceeds to step 320, where the method 300 receives a conference activity as described previously in step 206 above. For example, the conference activity may be a poll to be presented to Group1 as follows:

Poll 3: Are you satisfied with your Creative Cloud subscription?
a) Yes
b) No

The method 300 then proceeds to step 322 where the method 300 displays the conference activity as specified (i.e., to participants who have a groupID of Group1) and receives responses.

The method 300 proceeds to step 324, where the method 300 determines whether any segmentation rules exist based on the responses to the poll. If the method 300 determines there are no segmentation rules based on the responses to the poll, the method 300 proceeds to step 328. However, if the method 300 determines that there are segmentation rules based on the responses to the poll, the method 300 proceeds to step 326, where the method 300 assigns GroupIDs according to the segmentation rules. For example, the segmentation rule may be: participants in Group1 who selected response “a” in Poll 3 are assigned a groupID of Group1A and participants in Group1 who selected response “b” in Poll 3 are assigned a groupID of Group1B.

The method 300 may repeat block 318 if additional conference activities are received. For example, a host may, after segmenting participants in to Group1A and Group1B create a conference activity that presents an open ended question in a chat area of the web conference to participants with a groupID of Group1A. The open ended question asks about the most-liked features and benefits of Creative Cloud. The host may then create a conference activity where the responses received from the open ended question are displayed in the chat area to participants with a groupID of Group2 or Group3 (i.e., participants who are planning to purchase Creative Cloud).

The method 300 proceeds to step 328, where the method 300 determines whether the web conference has ended. If the method 300 determines that the web conference has not ended, the method 300 proceeds to step 310 and iterates until the method 300 determines at step 328 that the web conference has ended. The method 300 proceeds to step 330 and ends.

The embodiments of the present invention may be embodied as methods, apparatus, electronic devices, and/or computer program products. Accordingly, the embodiments of the present invention may be embodied in hardware and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium include the following: hard disks, optical storage devices, a transmission media such as those supporting the Internet or an intranet, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object oriented programming language, such as Java™, Smalltalk or C++, and the like. However, the computer program code for carrying out operations of the present invention may also be written in conventional procedural programming languages, such as the “C” programming language and/or any other lower level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

The methods described herein may be implemented in software, hardware, or a combination thereof, in different embodiments. In addition, the order of methods may be changed, and various elements may be added, reordered, combined, omitted, modified, etc. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer implemented method comprising:
segmenting participants of a web conference into a plurality of groups; and
presenting to each group in the plurality of groups one or more conference activities, wherein the one or more conference activities for a first group in the plurality of groups is different from the one or more conference activities for a second group in the plurality of groups.

2. The method of claim 1, wherein segmenting is based on a participant response to a conference activity.

3. The method of claim 1, wherein segmenting is based on static information, wherein static information is identifying information regarding a participant.

4. The method of claim 1, wherein a conference activity is at least one of a plurality of presentation slides, a poll, or a text chat message.

5. The method of claim 1, wherein conference activities are at least one of a pre-defined conference activity or a conference activity created during the web conference.

6. The method of claim 5, wherein the created conference activity comprises a time to display the conference activity and one or more groups to whom the conference activity is to be displayed.

7. The method of claim 1, further comprising presenting a host of the web conference a display comprising a view of what is presented to each group in the plurality of groups.

8. An apparatus for managing activities in a web conference comprising:
a computer having one or more processors and further comprising:
a conference management module for segmenting participants of a web conference into a plurality of groups, and presenting to each group in the plurality of groups one or more conference activities, wherein the one or more conference activities for a first group in the plurality of groups is different from the one or more conference activities for a second group in the plurality of groups.

9. The apparatus of claim 8, wherein the conference management module segments based on a participant response to a conference activity.

10. The apparatus of claim 8, wherein the conference management module segments based on static information, wherein static information is identifying information regarding a participant.

11. The apparatus of claim 8, wherein the one or more conference activities is at least one of a plurality of presentation slides, a poll, or a text chat message.

12. The apparatus of claim 8, wherein the one or more conference activities are at least one of a pre-defined conference activity or a conference activity created during the web conference, and wherein the created conference activity comprises a time to display the conference activity and one or more groups to whom the conference activity is to be displayed.

13. The apparatus of claim 8, wherein the conference management module presents a host of the web conference a display comprising a view of what is presented to each group in the plurality of groups.

14. A non-transient computer readable medium for storing computer instructions that, when executed by at least one processor causes the at least one processor to perform a method for managing activities in a web conference comprising:
segmenting participants of a web conference into a plurality of groups; and
presenting to each group in the plurality of groups one or more conference activities, wherein the one or more conference activities for a first group in the plurality of groups is different from the one or more conference activities for a second group in the plurality of groups.

15. The computer readable medium of claim 14, wherein segmenting is based on a participant response to a conference activity.

16. The computer readable medium of claim 14, wherein segmenting is based on static information, wherein static information is identifying information regarding a participant.

17. The computer readable medium of claim 14, wherein a conference activity is at least one of a plurality of presentation slides, a poll, or a text chat message.

18. The computer readable medium of claim 14, wherein conference activities are at least one of a pre-defined conference activity or a conference activity created during the web conference.

19. The computer readable medium of claim 18, wherein the created conference activity comprises a time to display the conference activity and one or more groups to whom the conference activity is to be displayed.

20. The computer readable medium of claim 14, further comprising presenting a host of the web conference a display comprising a view of what is presented to each group in the plurality of groups.
